(19) United States
(12) Patent Application Publication
(10) Pub. No.: US 2025/0062413 A1
(43) Pub. Date: Feb. 20, 2025

(54) ELECTROLYTE SOLUTION FOR LITHIUM SECONDARY BATTERY AND LITHIUM SECONDARY BATTERY INCLUDING THE SAME

(71) Applicants: SK ON CO., LTD., Seoul (KR); SK INNOVATION CO., LTD., Seoul (KR)

(72) Inventors: Seon Yeong PARK, Daejeon (KR); Min Young LEE, Daejeon (KR); Jong Chan KIM, Daejeon (KR); Seong Ho JIN, Daejeon (KR)

(21) Appl. No.: 18/798,832

(22) Filed: Aug. 9, 2024

(30) Foreign Application Priority Data
Aug. 18, 2023 (KR) 10-2023-0108292

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0037

(57) ABSTRACT

An electrolyte solution for a lithium secondary battery and a lithium secondary battery including the electrolyte solution are provided. The electrolyte solution includes an additive containing a compound having a specific structure, an organic solvent and a lithium salt. Accordingly, the lithium secondary battery including the electrolyte solution has improved rapid charging performance, life-span properties, and high-temperature storage properties.

### CROSS-REFERENCE TO RELATED APPLICATION AND CLAIM OF PRIORITY

This application claims priority to Korean Patent Applications No. 10-2023-0108292 filed on Aug. 18, 2023 in the Korean Intellectual Property Office (KIPO), the entire disclosure of which is incorporated by reference herein.

### TECHNICAL FIELD

The present disclosure relates to an electrolyte solution for a lithium secondary battery and a lithium secondary battery including the same. More particularly, the present disclosure relates to an electrolyte solution for a lithium secondary battery including a solvent and an electrolyte salt, and a lithium secondary battery including the same.

### BACKGROUND

A secondary battery which can be charged and discharged repeatedly has been widely employed as a power source of a mobile electronic device such as a camcorder, a mobile phone, a laptop computer.

For example, a lithium secondary battery is widely developed and applied due to high operational voltage and energy density per unit weight, a high charging rate, a compact dimension, etc.

For example, the lithium secondary battery may include an electrode assembly including a cathode, an anode and a separator, and an electrolyte solution immersing the electrode assembly. The lithium secondary battery may further include an outer case having, e.g., a pouch shape for accommodating the electrode assembly and the electrolyte solution.

The cathode of the lithium secondary battery may be prepared by, e.g., coating, drying and pressing a cathode slurry that may include a cathode active material and a binder optionally with a conductive material on a cathode current collector.

The cathode active material may be a material capable of reversibly intercalating and de-intercalating lithium ions. For example, the cathode active material may be a lithium metal oxide including a metal element such as nickel (Ni), cobalt (Co), manganese (Mn), etc.

As an application range of lithium secondary batteries is expanded, enhanced life-span properties, high capacity and operation stability are required. Accordingly, developments of a lithium secondary battery that provides uniform power and capacity even during repeated charging and discharging are needed.

### SUMMARY

According to an aspect of the present disclosure, there is provided an electrolyte solution for a lithium secondary battery having improved chemical stability.

According to an aspect of the present invention, there is provided a lithium secondary battery having improved rapid charging, life-span and high-temperature storage properties.

An electrolyte solution for a secondary battery includes an additive including a compound having a structure represented by Chemical Formula 1, an organic solvent and a lithium salt.

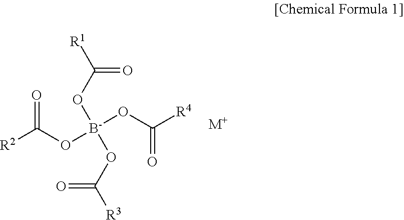

In Chemical Formula 1, R¹ to R⁴ are each independently a C1 to C10 alkyl group in which at least one hydrogen atom is substituted with a halogen atom, and M⁺ is a cesium cation, a potassium cation, a lithium cation, a sodium cation or a rubidium cation.

In some embodiments, R¹ to R⁴ may each independently be a C1 to C10 alkyl group in which all hydrogen atoms are substituted with halogen atoms.

In some embodiments, the halogen atom may be a fluorine atom, and M⁺ may be the cesium cation or the potassium cation.

In some embodiments, R¹ to R⁴ may each independently be a C1 to C10 alkyl group in which all hydrogen atoms are substituted with fluorine atoms.

In some embodiments, the compound having the structure represented by Chemical Formula 1 may include a compound having a structure represented by Chemical Formula 2-1 or Chemical Formula 2-2.

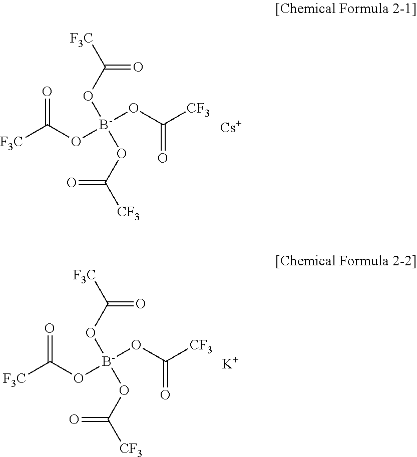

In some embodiments, the organic solvent may include at least one selected from the group consisting of a carbonate-based organic solvent, an ester-based organic solvent, an ether-based organic solvent, a ketone-based organic solvent and an aprotic organic solvent.

In some embodiments, the organic solvent may include a cyclic carbonate-based solvent and a linear carbonate-based solvent.

In some embodiments, a volume ratio of the cyclic carbonate-based solvent relative to the linear carbonate-based solvent in the organic solvent may be in a range from 1/9 to 1.

In some embodiments, a content of the additive may be in a range from 0.1 wt % to 10 wt % based on a total weight of the electrolyte solution.

In some embodiments, the electrolyte solution may further include at least one auxiliary additive selected from the group consisting of a fluorine-containing carbonate-based compound, a lithium phosphate-based compound, a sultone-based compound and a sulfate-based compound.

In some embodiments, a content of the auxiliary additive may be in a range from 0.01 wt % to 10 wt % based on a total weight of the electrolyte solution.

In some embodiments, a weight ratio of the auxiliary additive relative to the additive in the electrolyte solution may be in a range from 0.1 to 5.

A lithium secondary battery includes an electrode assembly including repeatedly stacked cathodes and anodes, and the above-described electrolyte solution for a lithium secondary impregnating the electrode assembly.

The electrolyte solution for a lithium secondary battery according to example embodiments may form a uniform solid electrolyte interphase (SEI) having a high ion conductivity on an electrode surface.

The lithium secondary battery according to example embodiments include the electrolyte solution to have improved rapid charging performance, life-span and high-temperature storage properties.

The electrolyte solution of the present disclosure may be widely applied in green technology fields such as an electric vehicle, a battery charging station, a solar power generation, a wind power generation, etc., using a battery, etc. The lithium secondary battery according to the present disclosure may be used for eco-friendly electric vehicles and hybrid vehicles to prevent a climate change by suppressing air pollution and greenhouse gas emissions, etc.

### BRIEF DESCRIPTION OF THE DRAWINGS

FIG. 1 is a schematic plan view illustrating a lithium secondary battery in accordance with example embodiments.

FIG. 2 is a schematic cross-sectional view illustrating a lithium secondary battery in accordance with example embodiments.

FIG. 3 is a graph showing peaks appearing in a Cs 1s spectrum in an XPS measurement of anodes of a lithium secondary battery according to Example 1 and Comparative Example 1.

FIG. 4 is a graph showing peaks in a B 1s spectrum in an XPS measurement of anodes of a lithium secondary battery according to Example 1 and Comparative Example 1.

FIG. 5 is a graph showing a voltage change of a lithium secondary battery according to Example 1.

### DETAILED DESCRIPTION OF THE EMBODIMENTS

The electrolyte solution for a lithium secondary battery according to embodiments of the present disclosure includes an additive including a compound having a specific structure, an organic solvent and a lithium salt.

Additionally, a lithium secondary battery according to embodiments includes an electrode assembly including repeatedly stacked cathodes and anodes, and the electrolytes solution for a lithium secondary battery impregnating the electrode assembly.

Accordingly, rapid charging performance, life-span and high-temperature storage properties of the lithium secondary battery may be improved.

The term “A-based compound” used herein may refer to a compound containing A, and a derivative of the compound.

Hereinafter, embodiments of the present disclosure will be described in more detail with reference to detailed examples and drawings. However, the present inventive concepts are not limited to the specific embodiments disclosed herein.

### <Electrolyte Solution for Lithium Secondary Battery>

An electrolyte solution for a lithium secondary battery (hereinafter, abbreviated as an electrolyte solution) according to embodiments of the present disclosure may include an additive including a compound having a structure represented by Chemical Formula 1, an organic solvent, and a lithium salt.

### Additive

The electrolyte solution for a lithium secondary battery according to example embodiments may include an additive including a compound having a structure represented by Chemical Formula 1.

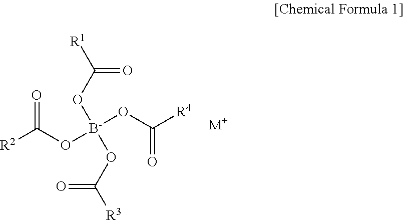

In Chemical Formula 1, R¹ to R⁴ may each independently be a C1 to C10 alkyl group in which at least one hydrogen atom is substituted with the halogen atom, and M⁺ may be a cesium cation, a potassium cation, a lithium cation, a sodium cation, or a rubidium cation.

For example, R¹ to R⁴ may each independently be a C1 to C8 alkyl group in which at least one hydrogen atom is substituted with the halogen atom, a C1 to C5 alkyl group in which at least one hydrogen atom is substituted with the halogen atom, or a C1 to C3 alkyl group in which at least one hydrogen atom is substituted with the halogen atom.

For example, the halogen atom may be a fluorine atom, a chlorine atom, a bromine atom, or an iodine atom.

In an embodiment, the halogen atom may be a fluorine atom.

For example, M⁺ may be the cesium cation or the potassium cation.

In some embodiments, R¹ to R⁴ may each independently be a C1 to C10 alkyl group in which all hydrogen atoms are substituted with halogen atoms.

For example, R¹ to R⁴ may each independently be a C1 to C8 alkyl group in which all hydrogen atoms are substituted with the halogen atoms, C1 to C5 alkyl group in which all hydrogen atoms are substituted with the halogen atoms, or a C1 to C3 alkyl group in which all hydrogen atoms are substituted the with halogen atoms.

For example, R¹ to R⁴ may each independently be a C1 to C10 alkyl group in which all hydrogen atoms are substituted with fluorine atoms, a C1 to C8 alkyl group in which all hydrogen atoms are substituted with the fluorine atoms, a C1 to C5 alkyl group in which all hydrogen atoms are substituted with the fluorine atoms, or a C1 to C3 alkyl group in which all hydrogen atoms are substituted with the fluorine atoms.

In an embodiment, R¹ to R⁴ may all be a trifluoromethyl group.

In some embodiments, the compound having the structure represented by Chemical Formula 1 may include a compound having a structure represented by Chemical Formula 2-1 or 2-2.

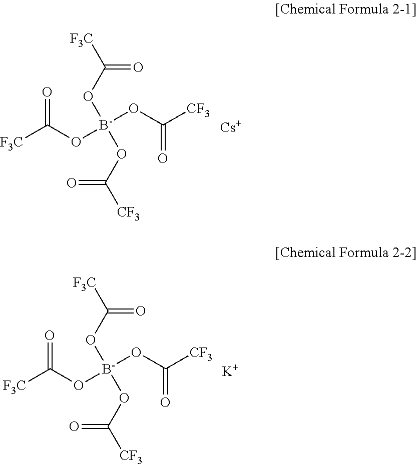

For example, the additive including the compound having the structure represented by Chemical Formula 1 may be included in the electrolyte solution, a uniform and high-ion conductivity solid electrolyte interface (SEI) film may be formed on an electrode surface.

For example, a film including B—O bond has a high ion conductivity, thereby reducing a battery resistance and improving rapid charging performance.

For example, an alkali metal cation such as the cesium cation included in the compound may not be reduced to inhibit a formation of a lithium dendrite, thereby forming a uniform and low-resistance film.

Accordingly, the rapid charging performance, life-span properties and high-temperature storage properties of the lithium secondary battery may be improved.

In some embodiments, a content of the additive may be in a range from 0.1 weight percent (wt %) to 10 wt % based on a total weight of the electrolyte solution.

For example, the content of the additive may be in a range from 0.2 wt % to 8 wt %, from 0.3 wt % to 5 wt %, from 0.4 wt % to 3 wt %, from 0.5 wt % to 2 wt %, or from 0.1 wt % to 2 wt % based on the total weight of the electrolyte solution.

In the above range, the SEI film having the uniform and high ionic conductivity may be formed, and mobility of lithium ions and activity of a cathode active material may not be hindered.

### Auxiliary Additive

The electrolyte solution for a lithium secondary battery according to example embodiments may further include an auxiliary additive including a cyclic carbonate-based compound, a fluorine-containing carbonate-based compound, a sultone-based compound, a sulfate-based compound, a cyclic sulfite-based compound, a lithium phosphate-based compound and/or a borate-based compound.

In some embodiments, the electrolyte solution may further include the auxiliary additive including the fluorine-containing carbonate-based compound, the lithium phosphate-based compound, the sultone-based compound and/or the sulfate-based compound.

The above-described additive may be used together with the auxiliary additive, so that the lithium secondary battery having more improved high-temperature storage properties may be efficiently implemented.

For example, the cyclic carbonate-based compound may include vinylene carbonate (VC), vinyl ethylene carbonate (VEC), etc.

For example, the fluorine-containing carbonate-based compound may include a fluorine atom or a substituent having a fluorine atom bonded to at least one carbon atom of the carbonate-based compound (e.g., a fluorine-substituted alkyl group such as —CF₃).

In some embodiments, the fluorine-containing carbonate-based compound may include a fluorine-containing cyclic carbonate-based compound including a cyclic structure. For example, the fluorine-containing cyclic carbonate-based compound may have a 5 to 7-membered cyclic structure.

For example, the fluorine-containing cyclic carbonate-based compound may include fluoroethylene carbonate (FEC).

In some embodiments, the lithium phosphate-based compound may include a fluorine-containing lithium phosphate-based compound.

For example, the fluorine-containing lithium phosphate-based compound may include a fluorine atom or a substituent group having a fluorine atom (for example, a fluorine-substituted alkyl group such as CF₃) bonded to a phosphorus atom of the lithium phosphate-based compound.

In some embodiments, the fluorine-containing lithium phosphate-based compound may include lithium difluoro phosphate (LiPO₂F₂), lithium difluoro (bis-oxalato) phosphate, etc. For example, the fluorine-containing lithium phosphate-based compound may include lithium difluorophosphate (LiPO₂F₂).

In some embodiments, the sultone-based compound may include at least one selected from the group consisting of an alkyl sultone-based compound and an alkenyl sultone-based compound.

In some embodiments, the sultone-based compound may include both the alkyl sultone-based compound and the alkenyl sultone-based compound.

For example, the alkyl sultone-based compound may include 1,3-propane sultone (PS) and 1,4-butane sultone.

For example, the alkenyl sultone-based compounds include ethene sultone, 1,3-propene sultone (PRS), 1,4-butene sultone, 1-methyl-1,3-propene sultone.

In some embodiments, the sulfate-based compound may include a cyclic sulfate-based compound including a cyclic structure. The cyclic sulfate-based compound may have a 5 to 7-membered cyclic structure.

For example, the cyclic sulfate-based compounds include 1,2-ethylene sulfate (ESA), trimethylene sulfate (TMS), 1,2-propylene sulfate, methyltrimethylene sulfate (MTMS).

For example, the cyclic sulfite-based compound may include ethylene sulfite, butylene sulfite, etc.

For example, the borate-based compound may include lithium bis(oxalato)borate.

In one embodiment, a content of the auxiliary additive may be in a range from 0.01 wt % to 10 wt % based on the total weight of the electrolyte solution.

For example, the content of the auxiliary additive may be in a range from 0.05 wt % to 9 wt %, from 0.5 wt % to 8 wt %, from 0.8 wt % to 7 wt %, from 1.0 wt % to 6 wt %, or from 1.5 wt % to 5 wt % based on the total weight of the electrolyte solution.

In the above range, durability of the SEI may be improved without the activity of the additive.

In some embodiments, a weight ratio of the auxiliary to the additive in the electrolyte solution may be in a range from 0.1 to 5.

For example, the weight ratio may be in a range from 0.2 to 4.8, from 0.3 to 4.5, from 0.4 to 4.0, or from 0.5 to 3.5. In the above range, the high-temperature storage and life-span properties of the lithium secondary battery may be further improved.

In an embodiment, the auxiliary additive may include the fluorine-containing carbonate-based compound, the lithium phosphate-based compound, the sultone-based compound and the sulfate-based compound together.

In some embodiments, the auxiliary additive may further include at least one selected from the group consisting of a borate-based compound, a nitrile-based compound, an amine-based compound, a silane-based compound and a benzene-based compound.

For example, the borate-based compound may include at least one selected from the group consisting of lithium tetraphenyl borate and lithium difluoro (oxalato) borate (LiODFB).

For example, the nitrile-based compound may include succinonitrile, adiponitrile, acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, 4-fluorophenylacetonitrile, etc. These may be used alone or in a combination of two or more therefrom. may be used alone or in a combination thereof.

For example, the amine-based compound may include triethanolamine, ethylene diamine, etc.

For example, the silane-based compound may include tetravinyl silane.

For example, the benzene-based compound may include at least one selected from the group consisting of monofluoro benzene, difluoro benzene, trifluoro benzene, and tetrafluoro benzene.

### Organic Solvent and Lithium Salt

For example, the organic solvent may include an organic compound that may have a sufficient solubility for the lithium salt, the additive and the auxiliary additive and may not be reactive in the lithium secondary battery.

In some embodiments, the organic solvent may include a carbonate-based solvent, an ester-based solvent, an ether-based solvent, a ketone-based solvent, an alcohol-based solvent and/or an aprotic solvent.

In some embodiments, the organic solvent may include the carbonate-based solvent, and the carbonate-based solvent may include a linear carbonate-based solvent and a cyclic carbonate-based solvent.

For example, the linear carbonate-based solvent includes dimethyl carbonate (DMC), ethyl methyl carbonate (EMC), diethyl carbonate (DEC), methyl propyl carbonate, ethyl propyl carbonate, dipropyl carbonate, etc.

For example, the cyclic carbonate-based solvent may include ethylene carbonate (EC), propylene carbonate (PC), butylene carbonate, etc.

In some embodiments, an amount of the linear carbonate-based solvent may be greater than or equal to that of the cyclic carbonate-based solvent based on a total volume of the organic solvent.

In some embodiments, a volume ratio of the volume of the cyclic carbonate-based solvent to the linear carbonate-based solvent in the organic solvent may be in a range from 1/9 to 1. For example, the volume ratio may be 1/9 to 1, from 1/9 to ⅔, from ⅙ to ⅔, or from ¼ to ⅔. In the above range, the high temperature storage properties of the lithium secondary battery may be further improved.

For example, the ester-based solvent may include at least one of methyl acetate (MA), ethyl acetate (EA), n-propyl acetate (n-PA), 1,1-dimethylethyl acetate (DMEA), methyl propionate (MP), ethyl propionate (EP), γ-butyrolactone (GBL), decanolide, valerolactone, mevalonolactone and caprolactone.

For example, the ether-based solvent may include at least one of dibutyl ether, tetraethylene glycol dimethyl ether (TEGDME), diethylene glycol dimethyl ether (DEGDME), dimethoxyethane, tetrahydrofuran (THF) and 2-methyltetrahydrofuran.

For example, the ketone-based solvent may include cyclohexanone.

For example, the alcohol-based solvent may include at least one of ethyl alcohol and isopropyl alcohol.

For example, the aprotic solvent may include a nitrile-based solvent, an amide-based solvent (e.g., dimethylformamide), a dioxolane-based solvent (e.g., 1,3-dioxolane) and/or a sulfolane-based solvent.

In some embodiments, the electrolyte solution may include the lithium salt.

The lithium salt may be represented by Li⁺X⁻. An anion of the lithium salt X⁻ may include F⁻, Cl⁻, Br⁻, I⁻, NO₃⁻, N(CN)₂⁻, BF₄⁻, ClO₄⁻, PF₆⁻, (CF₃)²PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻; CF₃CO₂⁻, CH₃CO₂⁻, SCN⁻, (CF₃CF₂SO₂)₂N⁻, etc.

In some embodiments, the lithium salt may include at least one of LiBF₄ and LiPF₆.

In some embodiments, the lithium salt may be included in a concentration from 0.01M to 5M, from 0.01M to 4M, from 0.5M to 3M, or from 0.5M to 2M based on the organic solvent. In the above concentration range, mobility of lithium ions and/or electrons may be facilitated during charging and discharging of the lithium secondary battery.

### <Lithium Secondary Battery>

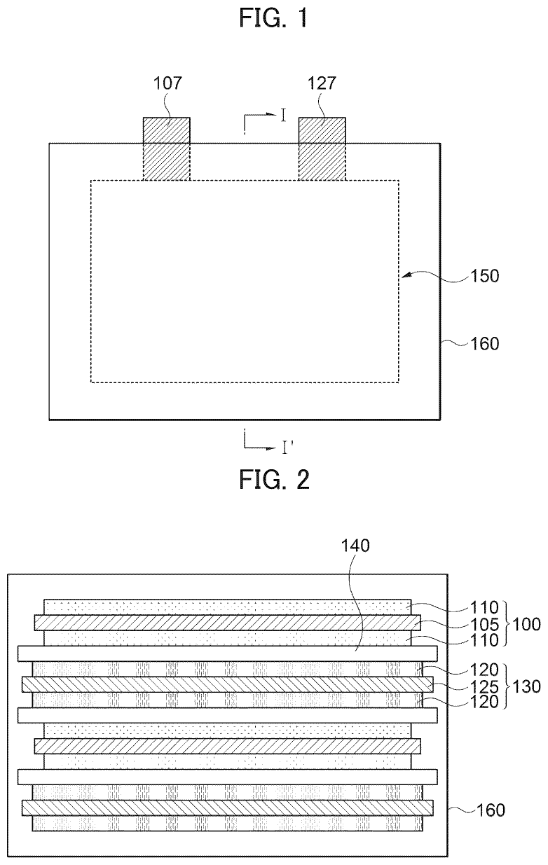

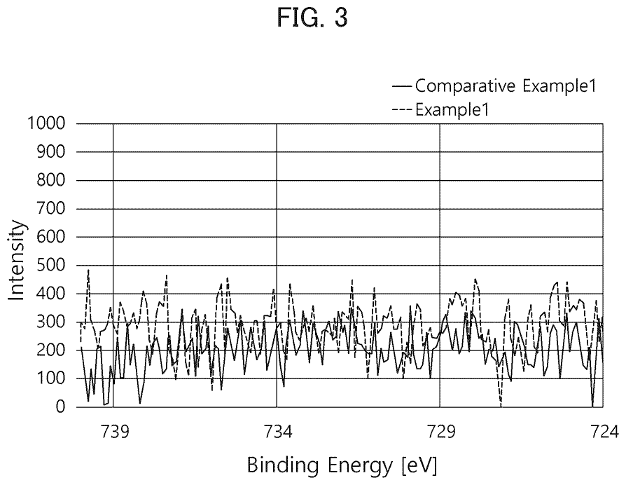

FIGS. 1 and 2 are a schematic plan view and a cross-sectional view, respectively, illustrating a lithium secondary battery in accordance with example embodiments. FIG. 2 is a cross-sectional view taken along a line I-I′ of FIG. 1.

Referring to FIGS. 1 and 2, the lithium secondary battery may include an electrode assembly 150 including a cathode 100, an anode 130, and a separator 140 interposed between the cathode and the anode.

For example, the electrode assembly 150 may include the cathode 100 and the anode 130 which are repeatedly stacked, and the electrode assembly 150 may include the electrolyte solution according to the above-described embodiments in a case 160 to be impregnated therein in the case 160.

The cathode 100 may include a cathode current collector 105 and a cathode active material layer 110 disposed on at least one surface of the cathode current collector 105.

For example, the cathode current collector 105 may include stainless steel, nickel, aluminum, titanium or an alloy thereof. The cathode current collector 105 may include aluminum or stainless steel surface treated with carbon, nickel, titanium, silver, etc. For example, a thickness of the cathode current collector 105 may be in a range from 10 μm to 50 μm.

The cathode active material may include a compound capable of reversibly intercalating and de-intercalating lithium ions.

In example embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Chemical Formula 3 below.

LiₓNiₐM_{b}O_{2+z} [Chemical Formula 3]

In Chemical Formula 3, 0.9≤x≤1.2, 0.5≤a≤0.99, 0.01≤b≤0.4, and −0.5≤z≤0.1. As described above, M may include Co, Mn and/or Al.

The chemical structure represented by Chemical Formula 3 represents a bonding relationship included in the layered structure or the crystal structure of the cathode active material or the lithium-transition nickel metal oxide particle, and does not exclude other additional elements. For example, M includes Co and/or Mn, and Co and/or Mn may serve as a main active element of the cathode active material together with Ni. Chemical Formula 3 is provided to express the bonding relationship of the main active element and is to be understood as a formula encompassing introduction and substitution of the additional elements.

In an embodiment, an auxiliary element for enhancing chemical stability of the cathode active material or the layered structure/crystal structure in addition to the main active element may be further included. The auxiliary element may be incorporated into the layered structure/crystal structure to form a bond, and this case is to be understood as being included within the range of the chemical structure represented by Chemical Formula 3.

The auxiliary element may include at least one of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al that contributes to capacity/power activity of the cathode active material together with Co or Mn.

For example, the cathode active material or the lithium-transition metal oxide particle may include a layered structure or a crystal structure represented by Chemical Formula 3-1.

LiₓNiₐM1_{b1}M2_{b2}O_{2+z} [Chemical Formula 3]

In Chemical Formula 1-1, M1 may include Co, Mn and/or Al. M2 may include the above-described auxiliary element. In Chemical Formula 3-1, 0.9≤x≤1.2, 0.5≤a≤0.99, 0.01≤b1+b2≤0.4, and −0.5≤z≤0.1.

The cathode active material above may further include a doping element. For example, elements substantially the same as or similar to the above-described auxiliary elements may be used as the doping element. For example, the above-described elements may be used alone or in a combination of two or more therefrom as the doping element.

The doping element may be present on a surface of the lithium-transition metal oxide particle, or may penetrate through the surface of the lithium-transition metal oxide particle to be included in the bonding structure represented by Chemical Formula 3 or Chemical Formula 3-1.

The cathode active material may include a nickel-cobalt-manganese (NCM)-based lithium oxide. In this case, an NCM-based lithium oxide having an increased nickel content may be used.

Ni may be provided as a transition metal related to the power and capacity of the lithium secondary battery. Thus, as described above, a high-capacity cathode and a high-capacity lithium secondary battery may be implemented using a high-Ni composition in the cathode active material.

However, as the content of Ni increases, long-term storage stability and life-span stability of the cathode or the secondary battery may be relatively lowered, and side reactions with an electrolyte may also be increased. However, according to example embodiments, life-span stability and capacity retention properties may be improved using Mn while maintaining an electrical conductivity by Co.

The content of Ni in the NCM-based lithium oxide (e.g., a mole fraction of nickel based on the total number of moles of nickel, cobalt and manganese) may be 0.6 or more, 0.7 or more, or 0.8 or more. In some embodiments, the content of Ni may be in a range from 0.8 to 0.95, from 0.82 to 0.95, from 0.83 to 0.95, from 0.84 to 0.95, from 0.85 to 0.95, or from 0.88 to 0.95.

In some embodiments, the cathode active material may include a lithium cobalt oxide-based active material, a lithium manganese oxide-based active material, a lithium nickel oxide-based active material, or a lithium iron phosphate (LFP) active material (e.g., LiFePO₄).

In some embodiments, the cathode active material may include, e.g., a Mn-rich active material having a chemical structure or a crystal structure represented by Chemical Formula 4, a Li-rich layered oxide (LLO)/OLO (Over-Lithiated Oxide)-based active material, a Co-less-based active material, etc.

p[Li₂MnO₃]·(1−p)[Li_{q}JO₂] [Chemical Formula 4]

In Chemical Formula 4, 0<p<1, 0.9≤q≤1.2, and J may include at least one element from Mn, Ni, Co, Fe, Cr, V, Cu, Zn, Ti, Al, Mg and B.

For example, a cathode mixture may be prepared by dispersing the cathode active material in a solvent. The cathode mixture may be coated on the cathode current collector 105, and the dried and pressed to form the cathode 100. The coating process may include a gravure coating, a slot die coating, a multi-layered simultaneous die coating, an imprinting, a doctor blade coating, a dip coating, a bar coating, a casting, etc.

The cathode mixture may further include a binder, and optionally may further include a conductive material, a thickener, etc.

Non-limiting examples of the solvent in the preparation of the cathode mixture include N-methyl-2-pyrrolidone (NMP), dimethylformamide, dimethylacetamide, N,N-dimethylaminopropylamine, ethylene oxide, tetrahydrofuran, etc.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR), etc. In an embodiment, a PVDF-based binder may be used as the cathode binder.

The conductive material may be added to improve conductivity of the cathode mixture layer and/or mobility of lithium ions or electrons. For example, the conductive material may include a carbon-based conductive material such as graphite, carbon black, acetylene black, Ketjen black, graphene, a carbon nanotube, a VGCF (vapor-grown carbon fiber), a carbon fiber, etc., and/or a metal-based conductive material such as tin, tin oxide, titanium oxide, a perovskite materials including LaSrCoO₃, LaSrMnO₃, etc.

For example, carboxymethyl cellulose (CMC) may be used as the thickener.

The anode 130 may include an anode current collector 125 and an anode active material layer 120 disposed on at least one surface of the anode current collector 125.

For example, non-limiting examples of the anode current collector 125 may include a copper foil, a nickel foil, a stainless steel foil, a titanium foil, a nickel foam, a copper foam, a polymer substrate coated with a conductive metal, etc. For example, a thickness of the anode current collector 135 may be in a range from 10 μm to 50 μm.

The anode active material layer 120 may include an anode active material. A material capable of adsorbing and desorbing lithium ions may be used as the anode active material. For example, the anode active material may include a carbon-based material such as a crystalline carbon, an amorphous carbon, a carbon composite, a carbon fiber, etc.; a lithium metal; a lithium alloy; a silicon (Si)-containing material or tin (Sn)-containing materials, etc.

For example, the amorphous carbon may include hard carbon, soft carbon, coke, a mesocarbon microbead (MCMB), a mesophase pitch-based carbon fiber (MPCF), etc.

For example, the crystalline carbon may include natural graphite, artificial graphite, a graphitized coke, a graphitized MCMB, a graphitized MPCF, etc.

The lithium metal may include a pure lithium metal or a lithium metal having a protective layer formed thereon for inhibiting a dendrite growth. In an embodiment, a lithium metal-containing layer deposited or coated on an anode current collector may be used as the anode active material layer 120. In an embodiment, a lithium thin film layer may be used as the anode active material layer.

An element capable of being included in the lithium alloy may include aluminum, zinc, bismuth, cadmium, antimony, silicon, lead, tin, gallium, indium, etc.

The silicon-containing material may provide an increased capacity. The silicon-containing material may include Si, a SiOx (0<x<2), a metal-doped silicate or SiOx (0<x<2), a silicon-carbon composite, etc. The metal may include lithium and/or magnesium.

For example, an anode mixture may be prepared by mixing the anode active material in a solvent. The anode mixture may be coated/deposited on the anode current collector, and then dried and pressed to form the anode. The coating process may include a gravure coating, a slot die coating, a multi-layered simultaneous die coating, an imprinting, a doctor blade coating, a dip coating, a bar coating, a casting, etc.

The anode mixture may further include a binder and optionally may further include a conductive material, a thickener, etc.

Non-limiting examples of the solvent for the anode mixture include water, pure water, deionized water, distilled water, ethanol, isopropanol, methanol, acetone, n-propanol, t-butanol, etc.

The above-described materials that may be used in the fabrication of the cathode may also be used as the binder, the conductive material and the thickener.

In some embodiments, the anode binder may include a styrene-butadiene rubber (SBR)-based binder, carboxymethyl cellulose (CMC), a polyacrylic acid-based binder, a poly(3,4-ethylenedioxythiophene) (PEDOT)-based binder, etc.

In some embodiments, a separator 140 may be interposed between the cathode 100 and the anode 130. The separator may prevent an electrical short circuit between the cathode 100 and the anode 130 while maintaining a flow of ions. For example, a thickness of the separator may be 10 μm to 20 μm.

For example, the separator 140 may include a porous polymer film or a porous non-woven fabric. The porous polymer film may include a polyolefin-based polymer such as an ethylene polymer, a propylene polymer, an ethylene/butene copolymer, an ethylene/hexene copolymer, an ethylene/methacrylate copolymer, etc.

The porous non-woven fabric may include a high melting point glass fiber, a polyethylene terephthalate fiber, etc.

The separator 140 may include a ceramic-based material. For example, inorganic particles may be coated on the polymer film or dispersed in the polymer film to improve a heat resistance.

The separator 140 may have a single-layered or multi-layered structure including the polymer film and/or the non-woven fabric as described above.

In example embodiments, the cathode 100, the anode 130 and the separator 140 may be repeatedly arranged to form the electrode assembly 150. In some embodiments, the electrode assembly 150 may be formed by winding, stacking, z-folding or stack-folding of the separator 140.

In an embodiment, the electrode assembly 150 may have a jelly roll shape formed by winding the cathode 100, the anode 130 and the separator 140 together. In an embodiment, the electrode assembly 150 may have a jelly roll shape in which notched anodes and cathodes are arranged in a space formed by repeatedly z-folding the separator 140.

In an embodiment, the electrode assembly may be formed by repeatedly stacking the cathode 100, the anode 130 and the separator 140 to be cut or separated at each level.

For example, electrode tabs (a cathode tab and an anode tab) may protrude from each of the cathode current collector 105 and the anode current collector 125 to one side of the case 160. The electrode tabs may be welded together with the one side of the case 160 to be connected to an electrode lead (a cathode lead 107 and an anode lead 127) that may be extended or exposed to an outside of the case 160.

For example, a pouch-type case, a prismatic-type case, a cylindrical case, a coin-type case, etc. may be used.

The electrode assembly 150 is accommodated in the case 160 together with the electrolyte solution described above to form a lithium secondary battery.

Hereinafter, exemplary experimental examples are proposed to more concretely describe the present disclosure. However, the following examples are only given for illustrating the present invention and those skilled in the related art will obviously understand that various alterations and modifications are possible within the scope and spirit of the present invention. Such alterations and modifications are duly included in the appended claims.

### Synthesis Example

### (1) Preparation of Additive I (cesium tetrakis(2,2,2-trifluoroacetoxy)borate)

0.41 g (6.6 mmol) of boric acid was added to a 10 mL solution of anhydrous dimethyl carbonate in which 1.6 g (6.5 mmol) of cesium trifluoroacetate was dispersed and cooled to 0° C. Thereafter, 5.0 g (24 mmol) of trifluoroacetic anhydride was slowly added to the mixture solution to obtain a transparent solution, a reflux condenser was connected, a temperature was increased to 80° C., and the mixture was stirred for 6 hours.

A concentrate obtained by drying the stirred solution was dissolved in tetrahydrofuran, solidified by adding dichloromethane, and then filtered to obtain 3.5 g of Additive I (yield 90%) having the form of a white solid and a structure represented by Chemical Formula 2-1 below.

¹⁹F NMR (470 MHz, DMSO-d₆): δ −75.8 (s, 12F)

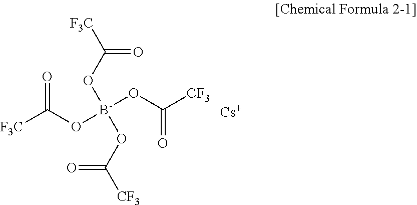

(cesium tetrakis(2,2,2-trifluoroacetoxy)borate)

### (2) Preparation of Additive II (potassium tetrakis(2,2,2-trifluoroacetoxy)borate)

0.41 g (6.6 mmol) of boric acid was added to a 10 mL solution of anhydrous dimethyl carbonate in which 1.0 g (6.6 mmol) of potassium trifluoroacetate was dispersed and cooled to 0° C. Thereafter, trifluoroacetic anhydride (5.0 g, 24 mmol) was slowly added to the mixture solution to obtain a transparent solution, a reflux condenser was connected, a temperature was increased to 80° C., and the mixture was stirred for 6 hours.

A concentrate obtained by drying the stirred solution was dissolved in tetrahydrofuran, solidified by adding dichloromethane, and then filtered to obtain 3.0 g of Additive II (yield 90%) having the form of a white solid and a structure represented by Chemical Formula 2-2 below.

¹⁹F NMR (470 MHz, DMSO-d₆): δ −75.8 (s, 12F)

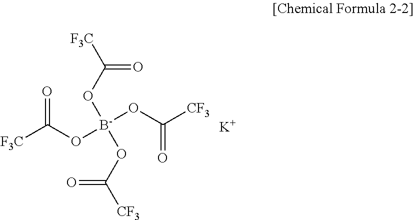 [SMILES: O=C(O[B-](OC(=O)C(F)(F)F)(OC(=O)C(F)(F)F)OC(=O)C(F)(F)F)C(F)(F)F ; [K+]]

(potassium tetrakis(2,2,2-trifluoroacetoxy)borate)

### EXAMPLE AND COMPARATIVE EXAMPLES

### Example 1

### (1) Preparation of Electrolyte Solution

A 1M LiPF₆ solution (ethylene carbonate (EC)/ethylmethyl carbonate (EMC) mixed solvent in a volume ratio of 25:75) was prepared.

Based on a total weight of the electrolyte solution (100 wt %), 1 wt % of fluoroethylene carbonate (FEC), 1 wt % of lithium difluorophosphate, 0.5 wt % of 1,3-propene sultone (PRS), 0.5 wt % of 1,3-propane sultone (PS) and 0.5 wt % of 1,2-ethylene sulfate (ESA) were added to the LiPF₆ solution, and 1 wt % of Additive I (cesium tetrakis(2,2,2-trifluoroacetoxy)borate) according to the above Synthesis Example was added to prepare aa electrolyte solution.

### (2) Fabrication of Lithium Secondary Battery Sample

A cathode active material including a mixture of Li[Ni_{0.6}Co_{0.2}Mn_{0.2}]O₂ and Li[Ni_{0.8}Co_{0.1}Mn_{0.1}]O₂ in a weight ratio of 6:4, a carbon black conductive material and a polyvinylidene fluoride (PVDF) binder were mixed and dispersed in an NMP solvent in a weight ratio of 92:5:3 to form a cathode slurry.

An aluminum foil (thickness: 15 μm) having a protrusion (a cathode tab) at one side thereof was prepared. The cathode slurry was uniformly coated on a region of the aluminum foil excluding the protrusion, dried, and then pressed to form a cathode.

An anode active material including artificial graphite and natural graphite in a weight ratio of 7:3, a styrene-butadiene rubber (SBR) binder and a carboxymethyl cellulose (CMC) thickener was mixed in distilled water in a weight ratio of 97:1:2 to prepare an anode slurry.

A copper foil (thickness: 15 μm) having a protrusion (an anode tab) at one side thereof was prepared. The anode slurry was uniformly coated on a region of the copper foil excluding the protrusion, dried, and pressed to form an anode.

An electrode assembly was formed by interposing a polyethylene separator (thickness: 20 μm) between the cathode and the anode. A cathode lead and an anode were welded and connected to the cathode tab and the anode tab, respectively.

The electrode assembly was accommodated in a pouch (case) so that portions of the cathode lead and the anode lead were exposed to an outside, and three sides except an electrolyte injection side were sealed.

A lithium secondary battery sample was prepared by injecting the electrolyte solution prepared in the above (1), sealing the electrolyte injection side, and performing an impregnation in the electrolyte solution for 12 hours.

### Example 2

An electrolyte solution and a lithium secondary battery sample were prepared by the same method as that in Example 1, except that 1 wt % of Additive II (potassium tetrakis(2,2,2-trifluoroacetoxy)borate) according to the above Synthesis Example was used instead of Additive I.

### Comparative Example 1

An electrolyte solution and a lithium secondary battery sample were prepared by the same method as that in Example 1, except that Additive I was not used.

### Comparative Example 2

An electrolyte solution was prepared by the same method as that in Example 1, except that 1 wt % of a compound having a structure represented by Chemical Formula 5 below was used instead of Additive I. The compound was not dissolved in the electrolyte solution, and subsequent evaluation was not conducted.

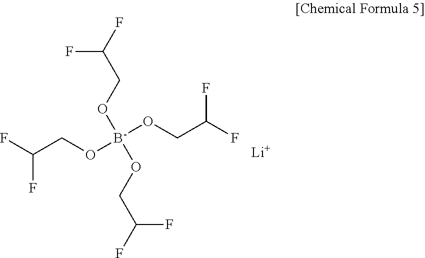 [SMILES: FC(F)CO[B-](OCC(F)F)(OCC(F)F)OCC(F)F ; [Li+]]

### Comparative Example 3

An electrolyte solution was prepared by the same method as that in Example 1, except that 1 wt % of a compound having a structure represented by Chemical Formula 6 below was used instead of Additive I. The compound was not dissolved in the electrolyte solution, and subsequent evaluation was not conducted.

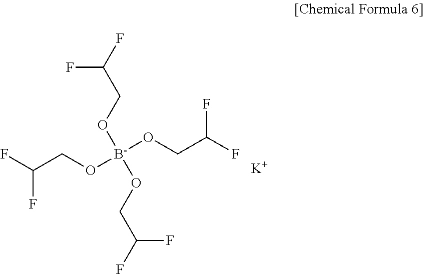 [SMILES: FC(F)CO[B-](OCC(F)F)(OCC(F)F)OCC(F)F ; [K+]]

### Experimental Examples

### Experimental Example 1: XPS Analysis of Anode

The anode of the lithium secondary battery according to each of Example 1 and Comparative Example 1 was analyzed by an X-ray photoelectron spectroscopy (XPS) (ESCALAB 250Xi, manufactured by Thermo Scientific) to determine a presence or an absence of a cesium element and a B—O bond.

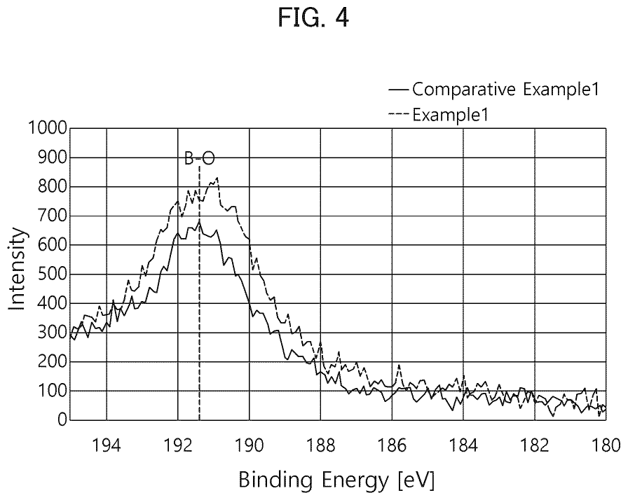

FIG. 3 is a graph showing peaks appearing in a Cs 1s spectrum in an XPS measurement of anodes of a lithium secondary battery according to Example 1 and Comparative Example 1.

FIG. 4 is a graph showing peaks in a B 1s spectrum in an XPS measurement of anodes of a lithium secondary battery according to Example 1 and Comparative Example 1.

Referring to FIG. 3, a peak of 726.4 eV representing the cesium element (Cs 3d_{5/2}) was not detected by the XPS measurement for the anode of the lithium secondary battery according to each of Example 1 and Comparative Example 1. Thus, and it can be assumed that a cesium cation was not reduced.

Referring to FIG. 4, in the XPS measurement of the anode of the lithium secondary battery according to each of Example 1 and Comparative Example 1, a peak of 191.5 eV indicating the B—O bond detected in the anode of Example 1 was higher than that of the anode of Comparative Example 1. Thus, it can be assumed that an SEI film containing the B—O bond was formed on the anode of the lithium secondary battery according to Example 1.

### Experimental Example 2: Initial Performance Evaluation (Room Temperature, 25° C.)

### (1) Initial Capacity Evaluation (Room Temperature, 25° C.)

The lithium secondary batteries of Examples and Comparative Examples were subjected to 0.5C-rate CC/CV charging (4.2V, 0.05C cut-off) and then 0.5C-rate CC discharging (2.7V cut-off) three times.

A discharge capacity value at the third cycle was measured as an initial capacity of the lithium secondary battery.

### (2) Internal Resistance (DCIR) Evaluation

At an SOC 60% point, a C-rate was changed to 0.2C, 0.5C, 1.0C, 1.5C, 2.0C, 2.5C or 3.0C. When the charging and discharging of the corresponding C-rate was performed for 10 seconds, an end point of a voltage was estimated by an equation of a straight line, and a slope was adopted as a DCIR.

### Experimental Example 3: Rapid Charging Performance Evaluation (Room Temperature, 25° C.)

For the lithium secondary batteries of Examples and Comparative Examples, a voltage (V) was differentiated by a capacity (Q) from SOC 8% to SOC 80% in a range of 1C-rate to 3C-rate. After monitoring a change rate (dV/dQ) for each SOC, a lithium plating point was predicted. An expected QC time was derived by setting optimal charging current and charging depth.

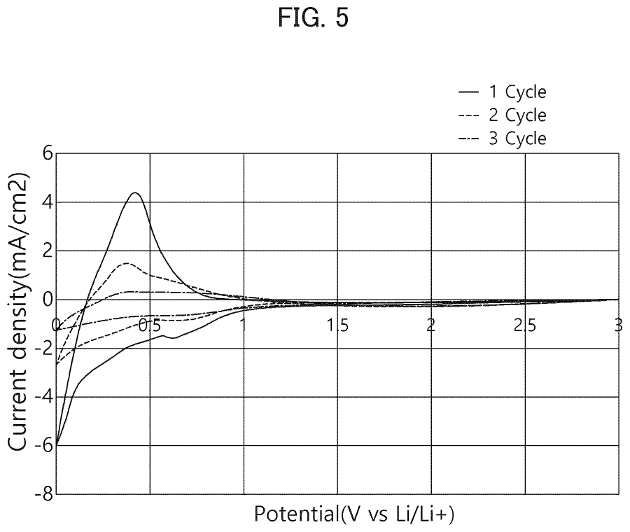

FIG. 5 is a graph showing a voltage change of a lithium secondary battery according to Example 1.

Referring to FIG. 5, in the first charge/discharge cycle of the lithium secondary battery according to Example 1, a reduction/decomposition peak appeared at 0.7V. Thus, it can be assumed that Additive I contained in the electrolyte solution of Example 1 was reduced and decomposed to form an SEI film.

### Experimental Example 4: Life-Span Evaluation (45° C.)

### (1) Evaluation on Capacity Retention

The lithium secondary batteries of Examples and Comparative Examples were charged at 1C to 4.2V at 45° C., and discharged at 1C to 2.75V. The charging and discharging were repeated 400 times, and a discharge capacity at the 400th cycle was measured.

A capacity retention calculated as a percentage of the discharge capacity at the 400th cycle relative to the initial capacity measured in (1) of Experimental Example 2.

### Experimental Example 5: Evaluation on High Temperature Storage Properties (60° C.)

The following evaluation was performed on the lithium secondary batteries of Examples and Comparative Examples “after high-temperature storage” in which the lithium secondary batteries were left in an air exposure condition of 60° C. for 12 weeks using a constant temperature apparatus and left for an additional 30 minutes at room temperature.

(1) Evaluation on Capacity Retention (Ret) after High-Temperature Storage

The charged lithium secondary batteries of Examples and Comparative Examples were discharged at 0.5C-rate CC (2.7V cut-off) after high-temperature storage to measure a discharge capacity.

A capacity retention was calculated as a percentage of the discharge capacity after high-temperature storage relative to the initial capacity measured in (1) of Experimental Example 2.

(2) Evaluation on Capacity Recovery (Rec) after High-Temperature Storage

After measuring the capacity retention according to the above (1) for the lithium secondary batteries of Examples and Comparative Examples, 0.5C-rate CC/CV charging (4.2V, 0.05C cut-off) and 0.5C-rate CC discharging (2.7V cut-off) were performed to measure a discharge capacity.

A capacity recovery was calculated as a percentage of the measured discharge capacity relative to the initial capacity measured in the above (1) of Experimental Example 2.

The evaluation results are shown in Table 1 below.

TABLE 1

| | | | | Comparative |
|---|---|---|---|---|
| | | Example 1 | Example 2 | Example 1 |
| initial | capacity | 1930 | 1912 | 1923 |
| performance | (mAh) | | | |
| | C_DCIR | 31.2 | 32.0 | 32.6 |
| | (mΩ) | | | |
| | D_DCIR | 32.8 | 33.2 | 35.1 |
| | (mΩ) | | | |
| rapid charging | QC time | 26.6 | 27.3 | 28.0 |
| perfomance¹⁾ | (min) | | | |
| 45° C. life-span²⁾ | Ret. | 88.4 | 85.5 | 85.5 |
| (400 cycles) | (%) | | | |
| 60° C. storage³⁾ | Ret. | 82.6 | 84.3 | 80.2 |
| (12 weeks) | (%) | | | |
| | Rec. | 86.6 | 86.0 | 83.5 |
| | (%) | | | |

¹⁾Step Charge SOC 8-80% at 25° C.
²⁾1 C/1 C 400 cycles at 45° C.
³⁾60° C. storage: 60° C. SOC100% 12 weeks

Referring to Table 1, the initial performance (reduction in resistance), the rapid charging performance, the life-span properties (increased capacity retention), and high-temperature (60° C.) storage properties (increased capacity retention and capacity recovery) were improved in the lithium secondary batteries of Examples.

In the lithium secondary battery of Comparative Example 1 that did not include the additive containing the compound of the specific structure, the initial resistance became high, the QC time was increased, and the capacity retention and capacity recovery after the high-temperature (60° C.) storage were lowered.

What is claimed is:

1. An electrolyte solution for a lithium secondary battery, comprising:
an additive comprising a compound having a structure represented by Chemical Formula 1;
an organic solvent; and
a lithium salt: 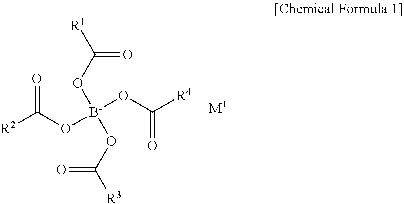
wherein, in Chemical Formula 1, R¹ to R⁴ are each independently a C1 to C10 alkyl group in which at least one hydrogen atom is substituted with a halogen atom, and
M⁺ is a cesium cation, a potassium cation, a lithium cation, a sodium cation or a rubidium cation.

2. The electrolyte solution for a lithium secondary battery according to claim 1, wherein R¹ to R⁴ are each independently a C1 to C10 alkyl group in which all hydrogen atoms are substituted with halogen atoms.

3. The electrolyte solution for a lithium secondary battery according to claim 1, wherein the halogen atom is a fluorine atom, and M⁺ is the cesium cation or the potassium cation.

4. The electrolyte solution for a lithium secondary battery according to claim 1, wherein R¹ to R⁴ are each independently a C1 to C5 alkyl group in which all hydrogen atoms are substituted with fluorine atoms.

5. The electrolyte solution for a lithium secondary battery according to claim 1, wherein the compound having the structure represented by Chemical Formula 1 includes a compound having a structure represented by Chemical Formula 2-1 or Chemical Formula 2-2:

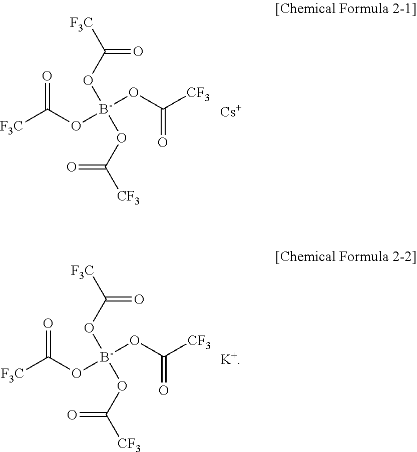

6. The electrolyte solution for a lithium secondary battery according to claim 1, wherein the organic solvent includes at least one selected from the group consisting of a carbonate-based organic solvent, an ester-based organic solvent, an ether-based organic solvent, a ketone-based organic solvent and an aprotic organic solvent.

7. The electrolyte solution for a lithium secondary battery according to claim 1, wherein the organic solvent includes a cyclic carbonate-based solvent and a linear carbonate-based solvent.

8. The electrolyte solution for a lithium secondary battery according to claim 7, wherein a volume ratio of the cyclic carbonate-based solvent relative to the linear carbonate-based solvent in the organic solvent is in a range from 1/9 to 1.

9. The electrolyte solution for a lithium secondary battery according to claim 1, wherein a content of the additive is in a range from 0.1 wt % to 10 wt % based on a total weight of the electrolyte solution.

10. The electrolyte solution for a lithium secondary battery according to claim 1, wherein the electrolyte solution further includes at least one auxiliary additive selected from the group consisting of a fluorine-containing carbonate-based compound, a lithium phosphate-based compound, a sultone-based compound and a sulfate-based compound.

11. The electrolyte solution for a lithium secondary battery according to claim 10, wherein a content of the auxiliary additive is in a range from 0.01 wt % to 10 wt % based on a total weight of the electrolyte solution.

12. The electrolyte solution for a lithium secondary battery according to claim 10, wherein a weight ratio of the auxiliary additive relative to the additive in the electrolyte solution is in a range from 0.1 to 5.

13. A lithium secondary battery, comprising:
an electrode assembly including repeatedly stacked cathodes and anodes; and
the electrolyte solution for a lithium secondary battery according to claim 1 impregnating the electrode assembly.
